(19) United States
(12) Patent Application Publication
(10) Pub. No.: US 2019/0062863 A1
(43) Pub. Date: Feb. 28, 2019

(54) HIGH-STRENGTH COLD ROLLED STEEL SHEET AND METHOD OF PRODUCING SAME

(71) Applicant: JFE STEEL CORPORATION, Chiyoda-ku Tokyo (JP)

(72) Inventors: Yuji TANAKA, Chiyoda-ku, Tokyo (JP); Sarka MIKMEKOVA, Chiyoda-ku, Tokyo (JP); Takako YAMASHITA, Chiyoda-ku, Tokyo (JP); Yoshie OBATA, Chiyoda-ku, Tokyo (JP)

(73) Assignee: JFE STEEL CORPORATION, Chiyoda-ku Tokyo (JP)

(21) Appl. No.: 16/075,747

(22) PCT Filed: Jan. 12, 2017
(86) PCT No.: PCT/JP2017/000878

§ 371 Date: Aug. 6, 2018

(30) Foreign Application Priority Data
Feb. 18, 2016 (JP) 2016-029273

(51) Int. Cl. C21D 9/46; C21D 8/02; C21D 6/00; C23C 2/02; C23C 2/40; C23C 2/06; B32B 15/01; C22C 38/04; C22C 38/06; C22C 38/02; C22C 38/00

(52) U.S. Cl. CPC C21D 9/46; C21D 2211/001; C21D 8/0226; C21D 8/0236; C21D 8/0263; C21D 8/0278; C21D 6/005; C21D 6/008; C23C 2/02; C23C 2/40; C23C 2/06; B32B 15/013; C22C 38/04; C22C 38/06; C22C 38/02; C22C 38/002; C22C 38/001; C21D 2211/005; C21D 2211/008; C21D 8/0205

(57) ABSTRACT

A high-strength cold rolled steel sheet has both high strength, i.e. a tensile strength of 900 MPa or more, and high workability, i.e. a total elongation of 20% or more, and also has a low yield ratio of less than 60%. The high-strength cold rolled steel sheet comprises: a predetermined chemical composition; and a steel structure having, in area ratio, ferrite: 30% to 75%, martensite: 15% to 40%, and retained austenite: 10% to 30%. In the case where a distribution of crystal grain circularity of the retained austenite is represented by a histogram with a class range of more than 0.1×(n−1) and 0.1×n or less and a class value of 0.1×n (n is an integer from 1 to 10), a mode of the crystal grain circularity of the retained austenite is 0.7 or more.

### TECHNICAL FIELD

The present disclosure relates to a high-strength cold rolled steel sheet and a method of producing the same, and in particular to a high-strength cold rolled steel sheet that has a low yield ratio and excellent workability.

### BACKGROUND

Various steel sheets with controlled steel structures (microstructures) have been developed in recent years, as steel sheets having both high strength and excellent workability.

For example, JP 5438302 B2 (PTL 1) discloses a high-yield-ratio and high-strength hot-dip galvanized steel sheet having excellent workability with a tensile strength of 980 MPa or more, and a method of producing the same.

JP 2015-014026 A (PTL 2) discloses an ultra-high-strength cold rolled steel sheet having excellent elongation and stretch flangeability with a tensile strength of 1180 MPa or more, and a method of producing the same.

### CITATION LIST

### Patent Literatures

PTL 1: JP 5438302 B2
PTL 2: JP 2015-014026 A

### SUMMARY

### Technical Problem

Working of a steel sheet for automobiles often involves press working. If the yield ratio is high, not only the load during press working is high, but also a problem of spring-back phenomenon in which the steel sheet tries to return to its original shape after the press working arises.

Moreover, to ensure crashworthiness of automobiles, it has been demanded in recent years to use, in automotive parts, steel sheets that deform easily at the time of a collision, to design such an automotive body structure that absorbs collision energy. Hence, the development of steel sheets that have both high strength and excellent workability and also have a low yield ratio has been desired.

The steel sheet described in PTL 1 is a steel sheet with a high yield ratio, and is not suitable for the above-mentioned purpose.

The steel sheet described in PTL 2 is not designed in consideration of the yield strength and the yield ratio.

Besides, both the steel sheet described in PTL 1 and the steel sheet described in PTL 2 may be unable to achieve sufficient ductility, and thus have a problem with workability.

It could be helpful to provide a high-strength cold rolled steel sheet that has both high strength, i.e. a tensile strength of 900 MPa or more, and excellent workability, i.e. a total elongation of 20% or more, and also has a low yield ratio, i.e. a yield ratio of less than 60%.

It could also be helpful to provide a method of producing the high-strength cold rolled steel sheet.

### Solution to Problem

As a result of repeatedly conducting close study in order to develop a high-strength cold rolled steel sheet that has both high strength, i.e. a tensile strength of 900 MPa or more, and excellent workability, i.e. a total elongation of 20% or more, and also has a low yield ratio, i.e. a yield ratio of less than 60%, we discovered the following points.

(1) To achieve both a tensile strength of 900 MPa or more and a total elongation of 20% or more, it is effective to appropriately adjust the chemical composition, and form the steel structure as a multi-phase structure that has ferrite, martensite, and retained austenite each at an appropriate mix proportion, to utilize the TRIP effect by retained austenite.

(2) The mechanical properties, and in particular the yield ratio, of the steel sheet are not determined uniquely by the chemical composition and the area ratio (hereafter also referred to as “microstructure proportion”) of each phase in the steel structure, and can vary greatly even in the case where the chemical composition and the microstructure proportions are approximately the same.

(3) We accordingly looked at the morphology of each phase, and conducted detailed observation and analysis on the steel structure using a field emission scanning electron microscope (FE-SEM). The results indicate that the morphology of retained austenite, and in particular the crystal grain circularity of retained austenite, influence the yield ratio of the steel sheet. By appropriately controlling the crystal grain circularity of retained austenite, the steel sheet can have a desired yield ratio.

(4) The crystal grain circularity of retained austenite in the final structure can be appropriately controlled by particularly adjusting the coiling temperature and the cooling conditions after hot rolling to form the hot rolled sheet structure before annealing treatment as a ferrite-pearlite dual phase structure, and subsequently performing annealing in the ferrite-austenite dual phase region and performing overaging treatment under predetermined conditions.

The present disclosure is based on these discoveries and further studies.

We thus provide:

1. A high-strength cold rolled steel sheet comprising: a chemical composition containing (consisting of), in mass %, C: 0.15% to 0.35%, Si: 1.0% to 2.0%, Mn: 1.8% to 3.5%, P: 0.020% or less, S: 0.0040% or less,

Al: 0.01% to 0.1%, and N: 0.01% or less, with a balance consisting of Fe and inevitable impurities; and a steel structure having, in area ratio, ferrite: 30% to 75%, martensite: 15% to 40%, and retained austenite: 10% to 30%, wherein in the case where a distribution of crystal grain circularity of the retained austenite is represented by a histogram with a class range of more than 0.1×(n−1) and 0.1×n or less and a class value of 0.1×n where n is an integer from 1 to 10, a mode of the crystal grain circularity of the retained austenite is 0.7 or more, and circularity of each crystal grain of the retained austenite is calculated according to the following formula:

circularity=4πS/L²

where S is an area of the crystal grain of the retained austenite, and L is a perimeter of the crystal grain of the retained austenite.

2. The high-strength cold rolled steel sheet according to 1, comprising a galvanized layer on a surface thereof.

3. A method of producing a high-strength cold rolled steel sheet, the method comprising: heating a steel slab to 1100° C. or more and 1200° C. or less, the steel slab containing, in mass %, C: 0.15% to 0.35%, Si: 1.0% to 2.0%, Mn: 1.8% to 3.5%, P: 0.020% or less, S: 0.0040% or less, Al: 0.01% to 0.1%, and N: 0.01% or less, with a balance consisting of Fe and inevitable impurities; thereafter hot rolling the steel slab at a finisher delivery temperature of 850° C. or more and 950° C. or less, to obtain a hot rolled sheet; cooling the hot rolled sheet, with a cooling rate in a temperature range from the finisher delivery temperature to 700° C. of 50° C./s or more; coiling the hot rolled sheet at 550° C. or more and 650° C. or less; thereafter cooling the hot rolled sheet to 100° C. or less by water cooling; pickling the hot rolled sheet; thereafter cold rolling the hot rolled sheet to obtain a cold rolled sheet; annealing the cold rolled sheet at 730° C. or more and 820° C. or less; thereafter cooling the cold rolled sheet to a temperature range of 300° C. or more and 500° C. or less; and performing an overaging treatment of holding the cold rolled sheet in the temperature range of 300° C. or more and 500° C. or less for 100 s or more and 1000 s or less.

4. The method of producing a high-strength cold rolled steel sheet according to 3, comprising performing a galvanizing treatment after the overaging treatment.

### Advantageous Effect

It is thus possible to obtain a high-strength cold rolled steel sheet that has both high strength, i.e. a tensile strength of 900 MPa or more, and excellent workability, i.e. a total elongation of 20% or more, and also has a low yield ratio, i.e. a yield ratio of less than 60%.

By using such a high-strength cold rolled steel sheet in a predetermined automotive part, an automotive body structure that absorbs collision energy at the time of a collision can be designed, and also fuel efficiency can be improved through automotive body weight reduction. The present disclosure is therefore industrially very useful.

### BRIEF DESCRIPTION OF THE DRAWINGS

In the accompanying drawings:

FIG. 1 is a diagram illustrating an example of a histogram representing a distribution of crystal grain circularity of retained austenite;

FIG. 2A is a diagram illustrating an example of a secondary electron image obtained in the case of observing a steel structure by an FE-SEM;

FIG. 2B is a diagram illustrating an example of an image obtained by observing the steel structure by EBSD and analyzing it by predetermined PC software;

FIG. 3A is a diagram illustrating an FE-SEM image (secondary electron image observed with an accelerating voltage of 15 kV at 2000 magnifications) indicating the steel structure of steel sheet No. 1 in Examples; and

FIG. 3B is a diagram illustrating an FE-SEM image (secondary electron image observed with an accelerating voltage of 1 kV at 5000 magnifications) indicating the steel structure of steel sheet No. 1 in Examples.

### DETAILED DESCRIPTION

One of the disclosed embodiments is described in detail below.

The reasons for limiting the chemical composition of a high-strength cold rolled steel sheet according to the present disclosure are given below. While the unit of the content of each element in the chemical composition is “mass %,” the unit is hereafter simply expressed by “%” unless otherwise specified.

C: 0.15% to 0.35%

C is an important element to contribute to higher strength of the steel sheet and obtain retained austenite. When producing the steel sheet according to the present disclosure, ferrite transformation progresses during overaging treatment after annealing. Since ferrite hardly dissolves C, C concentrates in non-transformed austenite, and austenite is stabilized. As a result, retained austenite is obtained in the final structure, thus improving elongation. Moreover, part of austenite in which the concentration of C is insufficient undergoes martensite transformation, and becomes a hard phase (martensite) in which C has been dissolved in a supersaturated state. This contributes to improved strength. If the C content is less than 0.15%, sufficient strength cannot be obtained. If the C content is more than 0.35%, weldability degrades noticeably. The C content is therefore in a range of 0.15% to 0.35%. The C content is preferably 0.15% or more. The C content is preferably 0.28% or less.

Si: 1.0% to 2.0%

Si is an important element to suppress cementite formation during overaging and obtain a sufficient amount of retained austenite. If the Si content is less than 1.0%, this effect cannot be achieved. If the Si content is more than 2.0%, surface oxidation during hot rolling and annealing is noticeable, which adversely affects appearance and coatability. The Si content is therefore in a range of 1.0% to 2.0%. The Si content is preferably 1.2% or more. The Si content is preferably 1.8% or less.

Mn: 1.8% to 3.5%

Mn has an effect of stabilizing retained austenite. If the Mn content is less than 1.8%, the effect is weak. If the Mn content is more than 3.5%, ferrite transformation during overaging treatment and retained austenite formation are suppressed, which makes it difficult to obtain desired elongation. The Mn content is therefore in a range of 1.8% to 3.5%. The Mn content is preferably 1.9% or more. The Mn content is preferably 2.5% or less.

P: 0.020% or Less

P decreases weldability, and so the P content is desirably as low as possible. The P content is therefore 0.020% or less. The P content is preferably 0.015% or less.

S: 0.0040% or Less

S forms inclusions and decreases local elongation, and so the S content is desirably as low as possible. The S content is therefore 0.0040% or less. The S content is preferably 0.0020% or less.

Al: 0.01% to 0.1%

Al is added as a deoxidizer. If the Al content is less than 0.01%, the effect is weak. If the Al content is more than 0.1%, inclusions form, and local elongation decreases. The Al content is therefore in a range of 0.01% to 0.1%. The Al content is preferably 0.02% or more. The Al content is preferably 0.06% or less.

N: 0.01% or Less

N is an element that affects strain ageing, and is desirably as low as possible. The N content is therefore 0.01% or less. The N content is preferably 0.006% or less.

The balance other than those described above consists of Fe and inevitable impurities. The chemical composition may further contain components other than those described above, without compromising the effects according to the present disclosure.

The steel structure of the high-strength cold rolled steel sheet according to the present disclosure is described below.

Area Ratio of Ferrite: 30% to 75%

Ferrite is a soft phase, and contributes to improved elongation. If the area ratio of ferrite is less than 30%, martensite increases and strength increases excessively, and elongation decreases. If the area ratio of ferrite is more than 75%, the area ratio of martensite decreases, and desired strength cannot be ensured. The area ratio of ferrite is therefore in a range of 30% to 75%. The area ratio of ferrite is preferably 40% or more. The area ratio of ferrite is preferably 70% or less.

Area Ratio of Martensite: 15% to 40%

Martensite is a hard phase, and contributes to improved strength. If the area ratio of martensite is less than 15%, desired strength cannot be ensured. If the area ratio of martensite is more than 40%, strength increases excessively, and elongation decreases. The area ratio of martensite is therefore in a range of 15% to 40%. The area ratio of martensite is preferably 20% or more. The area ratio of martensite is preferably 35% or less.

Area Ratio of Retained Austenite: 10% to 30%

Retained austenite greatly contributes to improved elongation through the TRIP effect. If the area ratio of retained austenite is less than 10%, desired elongation cannot be obtained. On the other hand, as the area ratio of retained austenite increases, the C concentration in retained austenite decreases, and the stability of retained austenite decreases. Hence, industrially obtaining retained austenite with an area ratio of more than 30% is difficult in terms of control. The area ratio of retained austenite is therefore in a range of 10% to 30%. The area ratio of retained austenite is preferably 12% or more. The area ratio of retained austenite is preferably 28% or less.

The steel structure is basically composed of ferrite, martensite, and retained austenite described above. The steel structure, however, may include trace amounts of carbides such as cementite and inclusions such as TiN, and their total area ratio of 1% or less is allowable.

Mode of Crystal Grain Circularity of Retained Austenite: 0.7 or More

The crystal grain circularity of retained austenite influences the yield ratio of the steel sheet, as mentioned earlier. By limiting the mode of crystal grain circularity of retained austenite to 0.7 or more, a desired low yield ratio, i.e. a yield ratio of less than 60%, can be obtained.

Although the mechanism in which the crystal grain circularity of retained austenite influences the yield ratio of the steel sheet is not entirely clear, we consider that microscopic stress distribution changes depending on morphology.

In detail, when the mode of crystal grain circularity of retained austenite (hereafter also simply referred to as “circularity”) is low, many crystal grains of retained austenite assume a long and narrow shape. In the case where a tensile load is applied to the steel sheet, how stress is applied differs depending on in which direction the shape of crystal grains of retained austenite extends with respect to the tensile direction. In such a case, crystal grains of retained austenite in a long and narrow shape, even when subjected to stress, do not undergo the TRIP phenomenon, and instead ferrite or martensite is subjected to the stress. Since the TRIP phenomenon is an irreversible plastic deformation, a phase yields if the TRIP phenomenon occurs. However, ferrite and martensite elastically deform when subjected to stress, and accordingly do not yield, but act to increase the yield ratio. Thus, when the mode of crystal grain circularity of retained austenite decreases, the yield ratio of the steel sheet increases. When the mode of crystal grain circularity of retained austenite increases, on the other hand, the TRIP phenomenon occurs in most of retained austenite in the steel, as a result of which the yield ratio decreases.

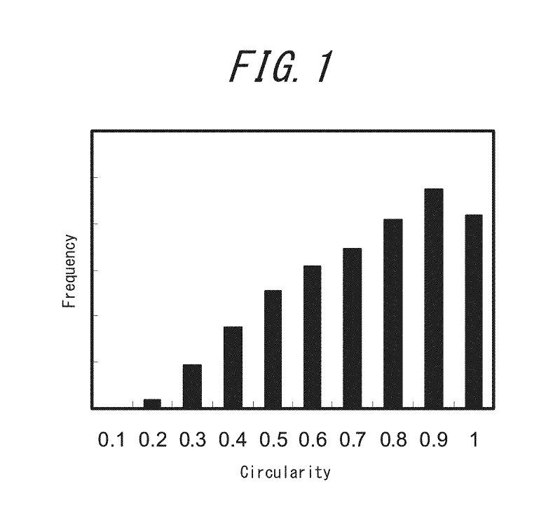

The mode of crystal grain circularity of retained austenite mentioned here is the mode of circularity in the case where the distribution of crystal grain circularity of retained austenite is represented by a histogram with a class range of more than 0.1×(n−1) and 0.1×n or less and a class value of 0.1×n (n is an integer from 1 to 10), as illustrated in FIG. 1. The “mode” denotes a class value corresponding to the maximum frequency (the number of crystal grains) in the above-mentioned circularity distribution. In FIG. 1, the mode is 0.9.

The circularity of each crystal grain of retained austenite is calculated according to the following formula:

circularity=4πS/L²

where S is the area of the crystal grain of retained austenite, and L is the perimeter of the crystal grain of retained austenite.

Given that crystal grains of retained austenite in the steel sheet have various morphologies, it is preferable to measure the circularity of each of 1000 or more crystal grains of retained austenite, in order to statistically determine circularity.

Moreover, it is preferable to measure the circularity of each crystal grain of retained austenite by image processing on an image observed by a field emission scanning electron microscope (FE-SEM).

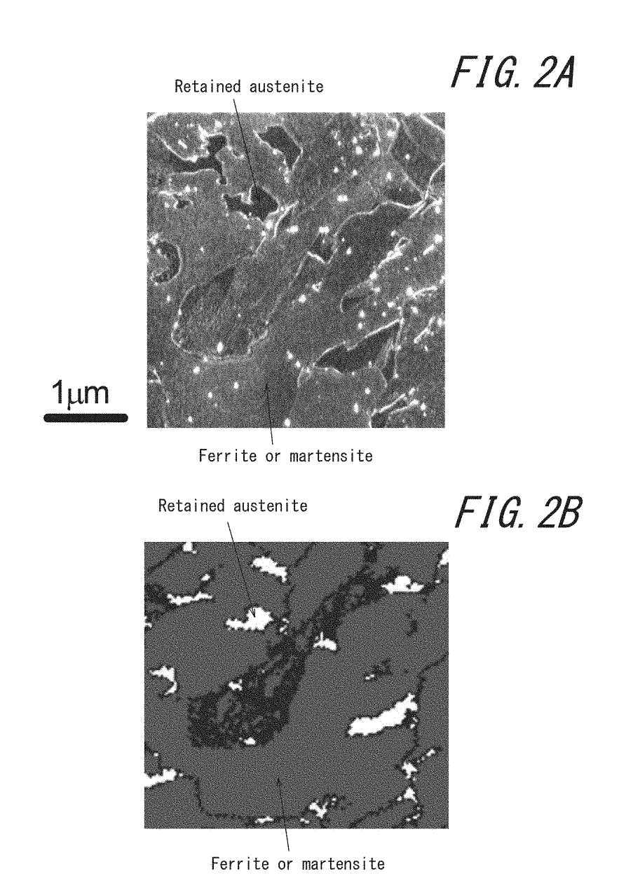

In detail, after mirror polishing a sample cross-section of a steel sheet, an appropriate structure etching process is performed, and secondary electron image observation is conducted by the FE-SEM. In this way, the morphology of retained austenite can be observed at high resolution, as illustrated in FIG. 2A. As the etching process, for example, nital and electropolishing etching may be used. By observing not a center part but a peripheral part of an etched region with an in-lens detector or an Everhart-Thornley detector of the FE-SEM, it is possible to observe retained austenite alone as being always darker than ferrite and martensite in contrast. Here, the accelerating voltage of the FE-SEM is preferably 2 kV or less (white portions in FIG. 2A represent residual particles of a polishing agent).

A method of attaching an electron backscattered diffraction (EBSD) detector to an SEM and analyzing an observed image by PC software is widely used as a technique of determining crystal phases of steel structures. However, in an image observed by EBSD, the boundaries of crystal grains of retained austenite of 50 nm or less in size (corresponding to white portions in FIG. 2B) are vague as illustrated in FIG. 2B, and the area S and perimeter L of each crystal grain of retained austenite cannot be accurately determined in some regions. In the above-mentioned FE-SEM image, on the other hand, even retained austenite of 50 nm or less in size is observable at high resolution. Thus, circularity can be measured with high accuracy, even for crystal grains of retained austenite of 50 nm or less in size.

As image processing for an FE-SEM observed image, image processing based on contrast may be used easily. For example, an image is binarized using ImageJ software which is free software, and circularity calculated from the area and perimeter of each extracted crystal grain of retained austenite is output.

The crystal grains of retained austenite subjected to circularity measurement are crystal grains with a crystal grain size (minor axis length) of 10 nm or more. Moreover, the number of crystal grains corresponding to a circularity class value of 0.7 or more is preferably more than 50% of all crystal grains.

A method of producing a high-strength cold rolled steel sheet according to the present disclosure is described below.

The method of producing a high-strength cold rolled steel sheet according to the present disclosure comprises: heating a steel slab having the chemical composition described above, to 1100° C. or more and 1200° C. or less; thereafter hot rolling the steel slab at a finisher delivery temperature of 850° C. or more and 950° C. or less, to obtain a hot rolled sheet; cooling the hot rolled sheet, with a cooling rate in a temperature range from the finisher delivery temperature to 700° C. of 50° C./s or more; coiling the hot rolled sheet at 550° C. or more and 650° C. or less; thereafter cooling the hot rolled sheet to 100° C. or less by water cooling; pickling the hot rolled sheet; thereafter cold rolling the hot rolled sheet to obtain a cold rolled sheet; annealing the cold rolled sheet at 730° C. or more and 820° C. or less; thereafter cooling the cold rolled sheet to 300° C. or more and 500° C. or less; and then performing an overaging treatment of holding the cold rolled sheet in the temperature range of 300° C. or more and 500° C. or less for 100 s or more and 1000 s or less.

The reasons for limiting the production method as described above are given below.

Slab Heating Temperature: 1100° C. or More and 1200° C. or Less

If the slab heating temperature is less than 1100° C., the rolling load increases, and problems such as an increased risk of troubles during hot rolling arise. If the slab heating temperature is more than 1200° C., the energy load for heating is high, and scale loss increases. The slab heating temperature is therefore 1100° C. or more and 1200° C. or less.

Finisher Delivery Temperature in Hot Rolling: 850° C. or More and 950° C. or Less

If the finisher delivery temperature in the hot rolling is less than 850° C., the deformation resistance during the hot rolling increases. If the finisher delivery temperature in the hot rolling is more than 950° C., crystal grains coarsen, and the strength decreases. The finisher delivery temperature in the hot rolling is therefore 850° C. or more and 950° C. or less.

Cooling Rate in Temperature Range from Finisher Delivery Temperature to 700° C.: 50° C./s or More

If the cooling rate in the temperature range from the finisher delivery temperature to 700° C. after the hot rolling is less than 50° C./s, the ferrite grain size increases, and the strength decreases. The cooling rate in the temperature range from the finisher delivery temperature to 700° C. is therefore 50° C./s or more.

Coiling Temperature: 550° C. or More and 650° C. or Less

The coiling temperature of the hot rolled sheet after the hot rolling is particularly important in limiting the crystal grain circularity of retained austenite in the final structure of the steel sheet to the predetermined range. In detail, in order to limit the crystal grain circularity of retained austenite to the predetermined range and obtain the desired low yield ratio, it is important to form the steel structure of the hot rolled sheet before annealing treatment as a ferrite-pearlite dual phase structure, and then perform annealing in the ferrite-austenite dual phase region. If the coiling temperature is less than 550° C., a low temperature transformation phase such as bainite forms in the steel structure of the hot rolled sheet. This causes many crystal grains of retained austenite obtained through the subsequent annealing and overaging treatment to have low circularity, and results in an increase in yield ratio. If the coiling temperature is more than 650° C., crystal grains coarsen, as a result of which not only the tensile strength decreases, but also the appearance and coatability decrease due to surface oxidation of Si or Mn. The coiling temperature is therefore 550° C. or more and 650° C. or less. The coiling temperature is preferably 560° C. or more, and more preferably 590° C. or more. The coiling temperature is preferably 620° C. or less.

Cooling Conditions after Coiling: Cooling to 100° C. or Less by Water Cooling

The cooling conditions after the coiling are also important in limiting the formation amount and crystal grain circularity of retained austenite in the final structure of the steel sheet to the predetermined ranges, as with the above-mentioned coiling temperature. In detail, in order to limit the formation amount and crystal grain circularity of retained austenite in the final structure of the steel sheet to the predetermined ranges, it is necessary to form the steel structure of the hot rolled sheet before annealing treatment as a ferrite-pearlite dual phase structure, and also appropriately control the nucleation site of austenite phase-transformed from ferrite during the annealing treatment.

By cooling the hot rolled sheet to 100° C. or less by water cooling after the coiling, carbon in the steel dissolves in ferrite grains. Such carbon dissolved in ferrite grains diffuses to and concentrates in pearlite during the annealing treatment, and austenite transformation occurs circularly from this pearlite. Thus, the desired formation amount and crystal grain circularity of retained austenite can be obtained in the final structure of the steel sheet.

If the cooling is not performed by water cooling or if the cooling stop temperature is more than 100° C., part of carbon segregates to ferrite grain boundaries, and austenite is transformed from ferrite grain boundaries during the annealing treatment and forms coarse austenite grains. Coarse austenite grains are low in carbon content, so that retained austenite is unstable. Consequently, the area ratio of retained austenite decreases, and ductility decreases.

Therefore, the cooling conditions after the coiling are that the hot rolled sheet is cooled to 100° C. or less by water cooling.

After coiling the hot rolled sheet, the hot rolled sheet is pickled. The hot rolled sheet is then cold rolled, to obtain a cold rolled sheet. The pickling conditions and the cold rolling conditions are not limited, and may comply with conventional methods.

Annealing Temperature: 730° C. or More and 820° C. or Less

The cold rolled sheet obtained in this way is then annealed. It is important to form, from the ferrite-pearlite dual phase structure of the hot rolled sheet formed during the coiling after the hot rolling, a ferrite-austenite dual phase structure, and perform annealing. In detail, ferrite becomes a structure low in dislocation density in the process of annealing, and contributes to improved ductility. Regarding pearlite, on the other hand, lamellar cementite spheroidizes in the process of annealing, from which austenite nucleates. As a result, a structure in which circular austenite is dispersed forms.

If the annealing temperature is less than 730° C., carbides (cementite) in pearlite do not melt. This causes insufficient C in martensite formed in the overaging treatment, and results in a decrease in strength. Besides, retained austenite obtained by the overaging treatment decreases, and ductility decreases. Furthermore, crystal grains with low circularity increase in retained austenite obtained by the overaging treatment.

If the annealing temperature is more than 820° C., the proportion of austenite during the annealing is excessive, and austenite grains connect to each other. This causes the formation of irregular-shaped austenite, as a result of which retained austenite obtained by the overaging treatment decreases, and ductility decreases. Moreover, crystal grains with low circularity increase in retained austenite obtained by the overaging treatment, and consequently the yield ratio increases. The annealing temperature is therefore 730° C. or more and 820° C. or less. The annealing temperature is preferably 740° C. or more. The annealing temperature is preferably 810° C. or less.

Overaging Treatment Conditions: Holding in Temperature Range of 300° C. or More and 500° C. or Less for 100 s or More and 1000 s or Less

After the annealing, the cold rolled sheet is cooled to a temperature range of 300° C. or more and 500° C. or less and then overaging treatment of holding the cold rolled sheet in this temperature range for 100 s or more and 1000 s or less is performed.

If the overaging treatment temperature is less than 300° C., austenite undergoes martensite transformation. As a result, a predetermined amount of retained austenite cannot be obtained, and elongation decreases. If the overaging treatment temperature is more than 500° C., ferrite transformation from austenite does not progress sufficiently, causing insufficient concentration of C in austenite. As a result, a predetermined amount of retained austenite cannot be obtained, and elongation decreases. The overaging treatment temperature is therefore 300° C. or more and 500° C. or less. The overaging treatment temperature is preferably 350° C. or more. The overaging treatment temperature is preferably 450° C. or less.

If the holding time in the overaging treatment is less than 100 s, ferrite transformation from austenite does not progress sufficiently, causing insufficient concentration of C in austenite. As a result, a predetermined amount of retained austenite cannot be obtained, and elongation decreases. If the holding time in the overaging treatment is more than 1000 s, productivity decreases. The holding time in the overaging treatment is therefore 100 s or more and 1000 s or less. The holding time is preferably 120 s or more. The holding time is preferably 600 s or less.

The steel sheet obtained as a result of the overaging treatment may be further subjected to galvanizing treatment, to form a galvanized layer on its surface. Examples of the galvanizing treatment include hot-dip galvanizing treatment, galvannealing treatment, and electrogalvanization treatment. The treatment conditions are not limited, and may comply with conventional methods.

### Examples

Steels having the respective chemical compositions listed in Table 1 with the balance consisting of Fe and inevitable impurities were each obtained by steelmaking to form a steel slab. The steel slab was then heated, and hot rolled to obtain a hot rolled sheet, under the conditions listed in Table 2. After cooling the obtained hot rolled sheet, the hot rolled sheet was coiled, and then cooled to 100° C. or less under the cooling conditions listed in Table 2. Subsequently, the hot rolled sheet was pickled with hydrochloric acid, and cold rolled at a rolling reduction of 40% to 60%, to obtain a cold rolled sheet (thickness: 0.8 mm to 1.0 mm). Subsequently, the cold rolled sheet was subjected to annealing and overaging treatment, under the conditions listed in Table 2.

TABLE 1

| | Chemical composition (mass %) | | | | | | | |
|---|---|---|---|---|---|---|---|---|
| Steel ID | C | Si | Mn | P | S | Al | N | Remarks |
| A | 0.25 | 1.5 | 2.0 | 0.006 | 0.002 | 0.02 | 0.003 | Conforming steel |
| B | 0.18 | 1.2 | 2.2 | 0.005 | 0.002 | 0.02 | 0.002 | Conforming steel |
| C | 0.11 | 1.8 | 3.0 | 0.005 | 0.002 | 0.02 | 0.003 | Comparative steel |
| D | 0.16 | 0.5 | 2.5 | 0.006 | 0.002 | 0.02 | 0.002 | Comparative steel |
| E | 0.27 | 1.8 | 3.8 | 0.006 | 0.002 | 0.02 | 0.002 | Comparative steel |
| F | 0.19 | 1.2 | 2.0 | 0.006 | 0.002 | 0.02 | 0.002 | Conforming steel |
| G | 0.30 | 1.8 | 2.4 | 0.010 | 0.002 | 0.04 | 0.003 | Conforming steel |
| H | 0.16 | 1.9 | 2.2 | 0.008 | 0.001 | 0.03 | 0.002 | Conforming steel |
| I | 0.20 | 1.2 | 3.2 | 0.008 | 0.002 | 0.02 | 0.002 | Conforming steel |

TABLE 2

| | | | | | | | | Overaging | |
|---|---|---|---|---|---|---|---|---|---|
| | | Slab heating | Finisher delivery | Cooling | Coiling | | Annealing | treatment | Holding time in |
| Steel sheet | | temperature | temperature | rate | temperature | Cooling conditions | temperature | temperature | overaging treatment |
| No. | Steel ID | (° C.) | (° C.) | (° C./s) | (° C.) | after coiling | (° C.) | (° C.) | (s) |
| 1 | A | 1150 | 880 | 60 | 590 | Water cooling | 740 | 400 | 120 |
| 2 | A | 1160 | 890 | 60 | 420 | Water cooling | 760 | 420 | 150 |
| 3 | A | 1150 | 870 | 60 | 600 | Water cooling | 840 | 410 | 200 |
| 4 | B | 1180 | 870 | 60 | 620 | Water cooling | 750 | 420 | 320 |
| 5 | B | 1180 | 880 | 60 | 600 | Water cooling | 720 | 420 | 150 |
| 6 | C | 1150 | 890 | 60 | 610 | Water cooling | 740 | 400 | 160 |
| 7 | D | 1160 | 880 | 60 | 600 | Water cooling | 750 | 410 | 250 |
| 8 | E | 1150 | 870 | 60 | 590 | Water cooling | 740 | 410 | 250 |
| 9 | F | 1170 | 880 | 60 | 600 | Natural cooling | 750 | 400 | 250 |
| 10 | G | 1120 | 880 | 100 | 620 | Water cooling | 750 | 380 | 400 |
| 11 | G | 1120 | 880 | 100 | 620 | Water cooling | 780 | 450 | 80 |
| 12 | G | 1120 | 880 | 100 | 620 | Water cooling | 810 | 340 | 800 |
| 13 | H | 1160 | 910 | 60 | 580 | Water cooling | 800 | 390 | 600 |
| 14 | H | 1160 | 910 | 60 | 580 | Water cooling | 830 | 350 | 400 |
| 15 | H | 1140 | 900 | 60 | 620 | Water cooling | 740 | 460 | 360 |
| 16 | I | 1160 | 870 | 60 | 640 | Water cooling | 760 | 380 | 800 |
| 17 | I | 1150 | 880 | 60 | 530 | Water cooling | 800 | 450 | 600 |
| 18 | I | 1180 | 890 | 60 | 610 | Natural cooling | 780 | 400 | 600 |
| 19 | I | 1160 | 910 | 60 | 660 | Water cooling | 740 | 420 | 400 |
| 20 | I | 1160 | 870 | 60 | 640 | Water cooling | 800 | 520 | 800 |

For each steel sheet produced in this way, the following structure observation and tensile test were conducted. The results are listed in Table 3.

### (1) Structure Observation

Area Ratio of Ferrite

The area ratio of ferrite was determined as follows: A cross-section of a sample taken from the produced steel sheet was mirror polished, and then etched by nital. Structure observation was then performed at a position of ¼ of the sheet thickness of the sample (position corresponding to ¼ of the sheet thickness from the surface in the depth direction), using FE-SEM LEO-1530 made by Carl Zeiss NTS GmbH.

Here, the accelerating voltage was set to 15 kV, and a secondary electron image was observed using an Everhart-Thronley (ET) detector. In the secondary electron image, crystal grains darker than their surroundings in contrast were regarded as ferrite, and the area ratio of ferrite to the whole observation field was determined.

The observation was performed for 10 observation fields at 5000 magnifications. The average of the area ratios of ferrite observed for the respective observation fields was set as the area ratio of ferrite.

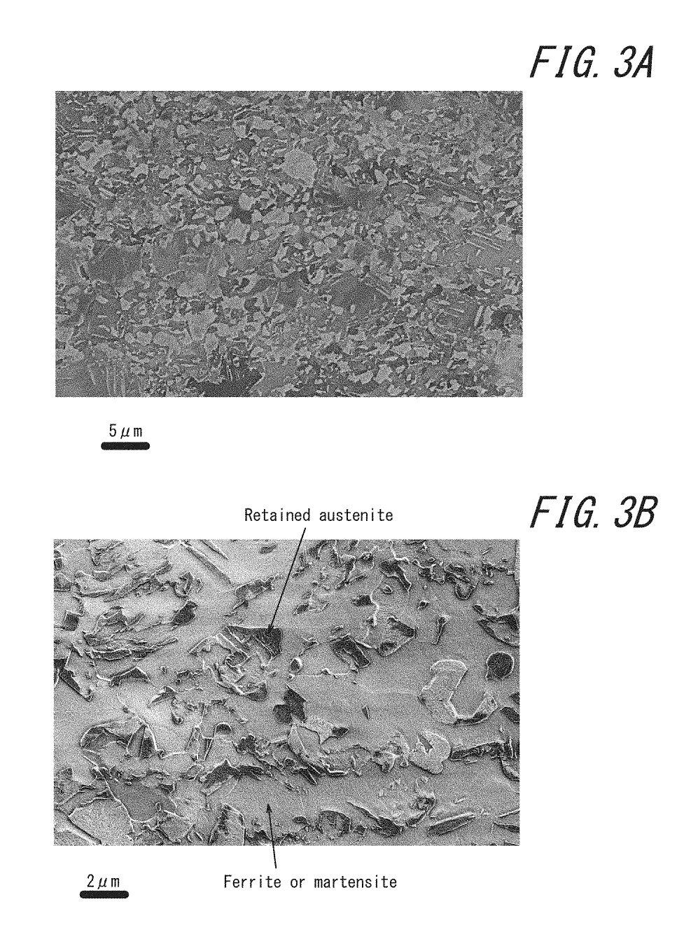

For reference, FIG. 3A illustrates an example of a secondary electron image obtained as a result of observing the steel structure of steel sheet No. 1 at 2000 magnifications.

Area Ratio of Retained Austenite

The area ratio of retained austenite was determined as follows: A cross-section of a sample taken from the produced steel sheet was mirror polished, and then electropolished with an electrolytic solution obtained by mixing methanol, butyl cellosolve, and perchloric acid at 10:6:1 in volume fraction. Structure observation was then performed at a position of ¼ of the sheet thickness of the sample, using FE-SEM LEO-1530 made by Carl Zeiss NTS GmbH.

Here, the accelerating voltage was set to 1 kV, and a secondary electron image was observed using an Everhart-Thornley detector. In the secondary electron image, crystal grains darker than their surroundings in contrast were regarded as retained austenite, and the area ratio of retained austenite to the whole observation field was determined.

The observation was performed for 10 observation fields at 5000 magnifications. The average of the area ratios of retained austenite observed for the respective observation fields was set as the area ratio of retained austenite.

For reference, FIG. 3B illustrates an example of a secondary electron image obtained as a result of observing the steel structure of steel sheet No. 1 at 5000 magnifications.

Area Ratio of Martensite

The area ratio of martensite was determined by subtracting the area ratio of ferrite and the area ratio of retained austenite determined above, from 100%.

Mode of Crystal Grain Circularity of Retained Austenite

With use of the sample used when determining the area ratio of retained austenite, structure observation was performed at a position of ¼ of the sheet thickness of the sample, using FE-SEM LEO-1530 made by Carl Zeiss NTS GmbH. The crystal grain circularity of retained austenite observed was determined by image analysis using ImageJ software.

The crystal grain circularity of retained austenite was calculated for 1000 crystal grains while changing the observation field. The distribution of crystal grain circularity of retained austenite calculated was represented by a histogram with a class range of more than 0.1×(n−1) and 0.1×n or less and a class value of 0.1×n (n is an integer from 1 to 10), and the mode was determined.

### (2) Tensile Test

A tensile test in compliance with JIS Z 2241 was performed using a JIS No. 5 test piece that complies with JIS Z 2201 and whose longitudinal direction (tensile direction) is at 90° with respect to the rolling direction of the steel sheet, to determine the yield strength (YS), the tensile strength (TS), the yield ratio (YR), and the total elongation (EL).

TABLE 3

| | | Steel structure | | | | | | | | |
|---|---|---|---|---|---|---|---|---|---|---|
| | | | | Area ratio of | Mode of crystal | | | | | |
| | | Area ratio of | Area ratio of | retained | grain circularity | Mechanical properties | | | | |
| Steel sheet | Steel | ferrite | martensite | austenite | of retained | YS | TS | YR | EL | |
| No. | ID | (%) | (%) | (%) | austenite | (MPa) | (MPa) | (%) | (%) | Remarks |
| 1 | A | 58 | 25 | 17 | 0.9 | 504 | 981 | 51 | 27 | Example |
| 2 | A | 62 | 21 | 17 | 0.5 | 702 | 920 | 76 | 33 | Comparative Example |
| 3 | A | 52 | 41 | 7 | 0.6 | 644 | 995 | 65 | 16 | Comparative Example |
| 4 | B | 57 | 29 | 14 | 0.8 | 638 | 1120 | 57 | 21 | Example |
| 5 | B | 70 | 24 | 6 | 0.6 | 629 | 863 | 73 | 18 | Comparative Example |
| 6 | C | 64 | 24 | 12 | 0.8 | 481 | 839 | 57 | 23 | Comparative Example |
| 7 | D | 60 | 36 | 4 | 0.6 | 629 | 968 | 65 | 15 | Comparative Example |
| 8 | E | 51 | 45 | 4 | 0.7 | 773 | 1317 | 59 | 7 | Comparative Example |
| 9 | F | 53 | 42 | 5 | 0.8 | 560 | 1013 | 55 | 12 | Comparative Example |
| 10 | G | 43 | 36 | 21 | 0.7 | 619 | 1081 | 57 | 22 | Example |
| 11 | G | 46 | 45 | 9 | 0.8 | 720 | 1290 | 56 | 11 | Comparative Example |
| 12 | G | 55 | 23 | 22 | 0.7 | 577 | 1005 | 57 | 24 | Example |
| 13 | H | 63 | 23 | 14 | 0.8 | 537 | 935 | 57 | 21 | Example |
| 14 | H | 48 | 44 | 8 | 0.6 | 691 | 1108 | 62 | 16 | Comparative Example |
| 15 | H | 66 | 18 | 16 | 0.7 | 513 | 911 | 56 | 23 | Example |
| 16 | I | 59 | 22 | 19 | 0.8 | 591 | 1094 | 54 | 21 | Example |
| 17 | I | 53 | 25 | 22 | 0.5 | 644 | 1026 | 63 | 23 | Comparative Example |
| 18 | I | 58 | 33 | 9 | 0.7 | 569 | 988 | 58 | 14 | Comparative Example |
| 19 | I | 61 | 25 | 14 | 0.9 | 473 | 865 | 55 | 25 | Comparative Example |
| 20 | I | 56 | 41 | 3 | 0.9 | 593 | 1062 | 56 | 7 | Comparative Example |

As can be seen from Table 3, all Examples exhibited high strength, i.e. a tensile strength of 900 MPa or more, and excellent workability, i.e. a total elongation of 20% or more, and also exhibited a low yield ratio, i.e. a yield ratio of less than 60%.

In Comparative Examples, on the other hand, at least one of the tensile strength, the total elongation, and the yield ratio was outside the desired range.

1. A high-strength cold rolled steel sheet comprising:
a chemical composition containing, in mass %,
C: 0.15% to 0.35%,
Si: 1.0% to 2.0%,
Mn: 1.8% to 3.5%,
P: 0.020% or less,
S: 0.0040% or less,
Al: 0.01% to 0.1%, and
N: 0.01% or less,
with a balance consisting of Fe and inevitable impurities; and
a steel structure having, in area ratio,
ferrite: 30% to 75%,
martensite: 15% to 40%, and
retained austenite: 10% to 30%,
wherein in the case where a distribution of crystal grain circularity of the retained austenite is represented by a histogram with a class range of more than 0.1×(n−1) and 0.1×n or less and a class value of 0.1×n where n is an integer from 1 to 10, a mode of the crystal grain circularity of the retained austenite is 0.7 or more, and
circularity of each crystal grain of the retained austenite is calculated according to the following formula:
circularity=4πS/L²
where S is an area of the crystal grain of the retained austenite, and L is a perimeter of the crystal grain of the retained austenite.

2. The high-strength cold rolled steel sheet according to claim 1, comprising
a galvanized layer on a surface thereof.

3. A method of producing a high-strength cold rolled steel sheet, the method comprising:
heating a steel slab to 1100° C. or more and 1200° C. or less, the steel slab containing, in mass %,
C: 0.15% to 0.35%,
Si: 1.0% to 2.0%,
Mn: 1.8% to 3.5%,
P: 0.020% or less,
S: 0.0040% or less,
Al: 0.01% to 0.1%, and
N: 0.01% or less,
with a balance consisting of Fe and inevitable impurities;
thereafter hot rolling the steel slab at a finisher delivery temperature of 850° C. or more and 950° C. or less, to obtain a hot rolled sheet;
cooling the hot rolled sheet, with a cooling rate in a temperature range from the finisher delivery temperature to 700° C. of 50° C./s or more;
coiling the hot rolled sheet at 550° C. or more and 650° C. or less;
thereafter cooling the hot rolled sheet to 100° C. or less by water cooling;
pickling the hot rolled sheet;
thereafter cold rolling the hot rolled sheet to obtain a cold rolled sheet;
annealing the cold rolled sheet at 730° C. or more and 820° C. or less;
thereafter cooling the cold rolled sheet to a temperature range of 300° C. or more and 500° C. or less; and
performing an overaging treatment of holding the cold rolled sheet in the temperature range of 300° C. or more and 500° C. or less for 100 s or more and 1000 s or less.

4. The method of producing a high-strength cold rolled steel sheet according to claim 3, comprising
performing a galvanizing treatment after the overaging treatment.
